(19) United States
(12) Patent Application Publication
(10) Pub. No.: US 2026/0187973 A1
(43) Pub. Date: Jul. 2, 2026

(54) IMAGE PROCESSING APPARATUS, IMAGE PROCESSING METHOD, AND COMPUTER-READABLE RECORDING MEDIUM

(71) Applicant: NEC Corporation, Tokyo (JP)

(72) Inventor: Yuya MATSUMOTO, Tokyo (JP)

(73) Assignee: NEC Corporation, Tokyo (JP)

(21) Appl. No.: 19/001,649

(22) Filed: Dec. 26, 2024

(51) Int. Cl. G06V 10/75; G06T 7/33; G06T 7/73; G06V 10/32

(52) U.S. Cl. CPC G06V 10/7515; G06T 7/337; G06T 7/74; G06V 10/32

(57) ABSTRACT

An image processing apparatus extracts first feature points from a first image, and second feature points from a second image obtained by capturing an image of a portion of a subject in the first image; specifies combinations of first feature point and second feature point that satisfy a setting requirement; normalizes position information of first feature point and second feature point such that a position of the first feature point and a position of the second feature point become closer to each other; encodes feature amounts of the first feature point and the second feature point in a state where the normalized position information is added thereto; and executes matching processing on the encoded first feature point and second feature point, and specifies a pair of first and second feature points that correspond to each other.

### CROSS-REFERENCE TO RELATED APPLICATIONS

This application is based upon and claims the benefit of priority from Japanese patent application No. 2024-033172, filed on Mar. 5, 2024, the disclosure of which is incorporated herein in its entirety by reference.

### BACKGROUND OF THE INVENTION

### 1. Field of the Invention

The present disclosure relates to a technique for executing feature point matching.

### 2. Background Art

In recent years, in the field of image processing, there have been cases where feature point matching is performed between two images. Feature point matching is a technique for comparing feature points extracted from one image with feature points extracted from the other image, and regarding feature points that match each other as a pair of feature points (for example, see Patent Document 1).

In addition, such feature point matching is used for a technique for generating three-dimensional point cloud data of an object from images (SfM (Structure from Motion)), a technique for searching for a target object from a specific image, and the like.

Patent Document 1, for example, discloses an apparatus that generates three-dimensional point cloud data of a target object by extracting feature points from a plurality of captured images of the target object, and performing feature point matching on the extracted feature points. Patent Document 2 discloses an apparatus that compares a specific image with a reference image of a target object, and searches for the target object in the specific image.

In addition, feature point matching may also be performed to specify where a portion of a target object is positioned in the entire target object. For the purpose of maintenance of a structure, feature point matching is performed to specify the position of a degraded part (such as a crack) of the structure, for example. In this case, feature point matching is performed between an enlarged image of the degraded part (such as a crack) of the structure and an overall image illustrating the entire structure, and the position of the degraded part in the structure is specified.
Patent Document 1: Japanese Patent Laid-Open Publication No. 2021-174285
Patent Document 2: Japanese Patent Laid-Open Publication No. 2012-190089

Incidentally, when specifying where a portion of a target object is positioned in the entire target object, the position of this portion significantly differs between an enlarged image and an overall image, as illustrated in FIG. 8. FIG. 8 is a diagram illustrating an example of an enlarged image and an overall image of a target object. FIG. 8 illustrates an overall image obtained by capturing an image of a structure and an enlarged image obtained by capturing an image of a portion of the structure.

In this case, different pieces of position information are provided to the feature amount of the portion of the enlarged image and the feature amount of the portion of the overall image. For this reason, the accuracy of feature point matching between the enlarged image and the overall image may significantly decrease. The smaller the difference between the feature amount of a portion of an enlarged image and the feature amount of a region surrounding the portion, the more the accuracy of feature point matching decreases, for example.

In addition, FIG. 9 is a diagram illustrating another example of an enlarged image and an overall image of a target object. Also when specifying where a specific building is positioned in a specific area as in FIG. 9, the above problem occurs. This is because, in this case, the position of the building significantly differs between an image of the specific area in which the building is located (overall image) and an image of only the building (enlarged image).

### SUMMARY OF INVENTION

An example object of the present disclosure is to solve the aforementioned problem, and to improve the accuracy of feature point matching in a portion whose position differs between images.

In order to achieve the above-described object, an image processing apparatus includes:
a feature point extracting unit configured to extract first feature points from a first image, and extract second feature points from a second image obtained by capturing an image of a portion of a subject in the first image;
a combination specifying unit configured to specify combinations of a first feature point and a second feature point that satisfy a setting requirement, from among the extracted first feature points and the second feature points;
a normalization processing unit configured to normalize position information of a first feature point and a second feature point such that a position of the first feature point and a position of the second feature point become closer to each other, for each of the specified combinations;
an encoding unit configured to encode feature amounts of the first feature point and the second feature point in a state where the normalized position information is added thereto; and
a matching processing unit configured to execute matching processing on the encoded first feature point and second feature point, and specify a pair of first and second feature points that correspond to each other.

In order to achieve the above-described object, an image processing method includes:
a feature point extracting step of extracting first feature points from a first image, and extracting second feature points from a second image obtained by capturing an image of a portion of a subject in the first image;
a combination specifying step of specifying combinations of a first feature point and a second feature point that satisfy a setting requirement, from among the extracted first feature points and the second feature points;
a normalization processing step of normalizing position information of a first feature point and a second feature point such that a position of the first feature point and a position of the second feature point becomes closer to each other, for each of the specified combinations;
an encoding step of encoding feature amounts of the first feature point and the second feature point in a state where the normalized position information is added thereto; and
a matching processing step of executing matching processing on the encoded first feature point and second feature point, and specifying a pair of first and second feature points that correspond to each other.

In order to achieve the above-described object, a computer readable recording medium according to an example aspect of the invention is a computer readable recording medium that includes recorded thereon a program,
the program including instructions that cause a computer to carry out:
a feature point extracting step of extracting first feature points from a first image, and extracting second feature points from a second image obtained by capturing an image of a portion of a subject in the first image;
a combination specifying step of specifying combinations of a first feature point and a second feature point that satisfy a setting requirement, from among the extracted first feature points and the second feature points;
a normalization processing step of normalizing position information of a first feature point and a second feature point such that a position of the first feature point and a position of the second feature point become closer to each other, for each of the specified combinations;
an encoding step for encoding feature amounts of the first feature point and the second feature point in a state where the normalized position information is added thereto; and
a matching processing step of executing matching processing on the encoded first feature point and second feature point, and specifying a pair of first and second feature points that correspond to each other.

As described above, according to the invention, it is possible to improve the accuracy of feature point matching in a portion whose position differs between images.

### BRIEF DESCRIPTION OF THE DRAWINGS

FIG. 1 is a configuration diagram illustrating a schematic configuration of an example of an image processing apparatus.

FIG. 2 is a configuration diagram illustrating a configuration of an example of the image processing apparatus in more detail.

FIG. 3 is a diagram illustrating an example of a matrix used to specify a pair of feature points.

FIG. 4 is a diagram for describing an example of normalization processing and encoding processing that are performed in the image processing apparatus.

FIG. 5 is a flowchart illustrating an example of operations of the image processing apparatus.

FIG. 6 is a diagram illustrating another example of encoding processing that is performed in the image processing apparatus.

FIG. 7 is a block diagram illustrating an example of a computer that realizes the image processing apparatus.

FIG. 8 is a diagram illustrating an example of an enlarged image and an overall image of a target object.

FIG. 9 is a diagram illustrating another example of an enlarged image and an overall image of a target object.

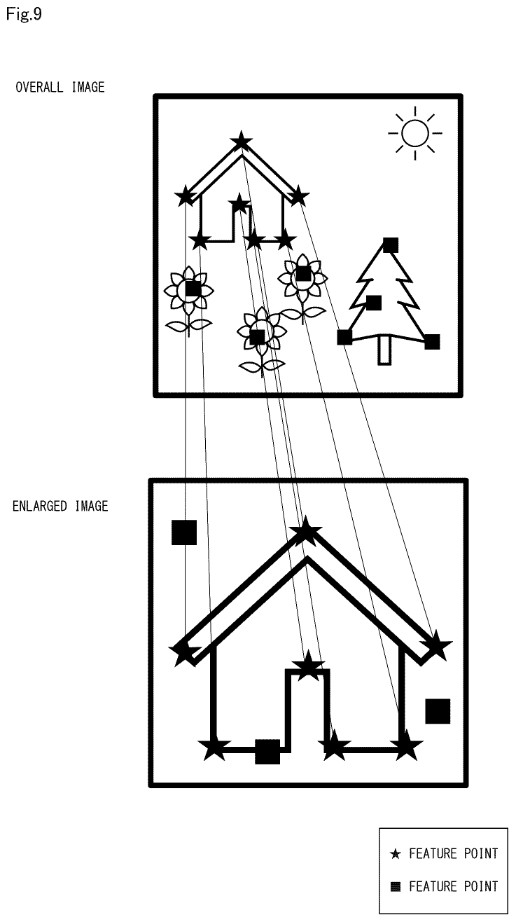

### EXAMPLE EMBODIMENT

### Example Embodiment

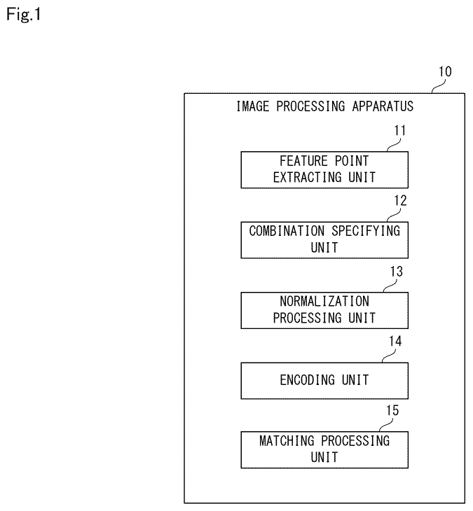

An image processing apparatus, an image processing method, and a program according to an example embodiment will be described below with reference to FIGS. 1 to 7.

### [Apparatus Configuration]

First, a schematic configuration of an example of an image processing apparatus will be described with reference to FIG. 1. FIG. 1 is a configuration diagram illustrating a schematic configuration of an example of an image processing apparatus.

An image processing apparatus 10 illustrated in FIG. 1 is an apparatus that executes feature point matching between images. As illustrated in FIG. 1, the image processing apparatus includes a feature point extracting unit 11, a combination specifying unit 12, a normalization processing unit 13, an encoding unit 14, and a matching processing unit 15.

The feature point extracting unit 11 extracts first feature points from a first image, and extracts second feature points from a second image obtained by capturing an image of a portion of a subject in the first image. The combination specifying unit 12 specifies combinations of a first feature point and a second feature point that satisfy a setting requirement, from among the extracted first feature points and second feature points.

The normalization processing unit 13 normalizes position information of a first feature point and a second feature point such that the position of the first feature point and the position of the second feature point become closer to each other, for each of the specified combinations. The encoding unit 14 encodes the feature amounts (descriptors) of the first feature point and the second feature point, in a state where the normalized position information is added thereto.

The matching processing unit 15 executes matching processing on the encoded first feature point and second feature point, and specifies a pair of first and second feature points that correspond to each other.

As described above, the image processing apparatus 10 normalizes the position information of the feature points in the combination of feature points specified first from the first image and the second image, and then executes feature point matching. For this reason, even if the first image and the second image are respectively an enlarged image of a target object and an overall image of the target object, for example, a decrease in the accuracy of feature point matching is avoided. That is to say, the image processing apparatus 10 makes it possible to improve the accuracy of feature point matching of a portion whose position differs between images.

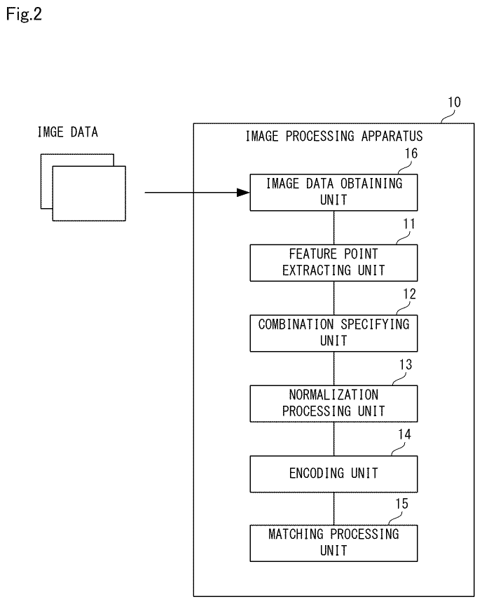

Next, a configuration and functions of an example of the image processing apparatus will be described in detail with reference to FIGS. 2 to 4. FIG. 2 is a configuration diagram illustrating a configuration of an example of the image processing apparatus in more detail.

As illustrated in FIG. 2, the image processing apparatus 10 includes an image data obtaining unit 16 in addition to the feature point extracting unit 11, the combination specifying unit 12, the normalization processing unit 13, the encoding unit 14, and the matching processing unit 15 illustrated in FIG. 1.

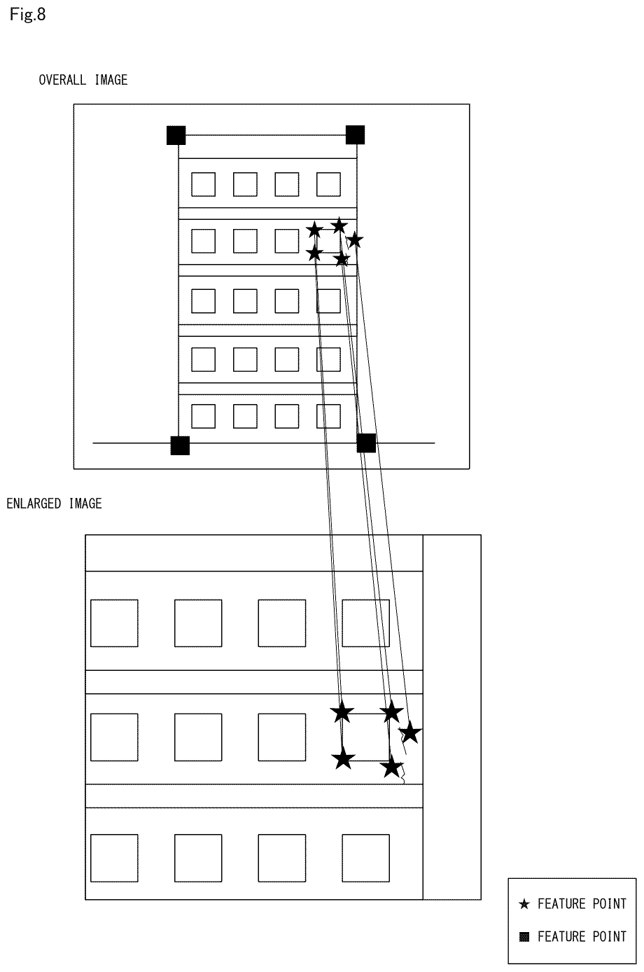

The image data obtaining unit 16 obtains image data of two images designated by the user through an input device or a terminal device from an external terminal device, a database, or the like. One of the two pieces of image data is image data of a first image, and the other is image data of a second image. In addition, assume that, in the following description, the first image is an overall image illustrated in FIG. 8 (hereinafter, also referred to as an “image A”), and the second image is an enlarged image illustrated in FIG. 8 (hereinafter, also referred to as an “image B”).

The feature point extracting unit 11 first calculates feature amounts such as Haar-Like feature amounts, HOG feature amounts, and SIFT feature amounts for the first image and the second image. Next, the feature point extracting unit 11 extracts, as feature points, points at which the values of feature amounts are greater than or equal to a predetermined value in each of the image A and the image B, for example.

In the example embodiment, the combination specifying unit 12 calculates a score for each combination of a first feature point and a second feature point, and specifies combinations for which the calculated score is greater than or equal to a threshold value. Specifically, the combination specifying unit 12 specifies combinations of a first feature point and a second feature point by executing exhaustive search matching such as optimal transport or dual sftmax.

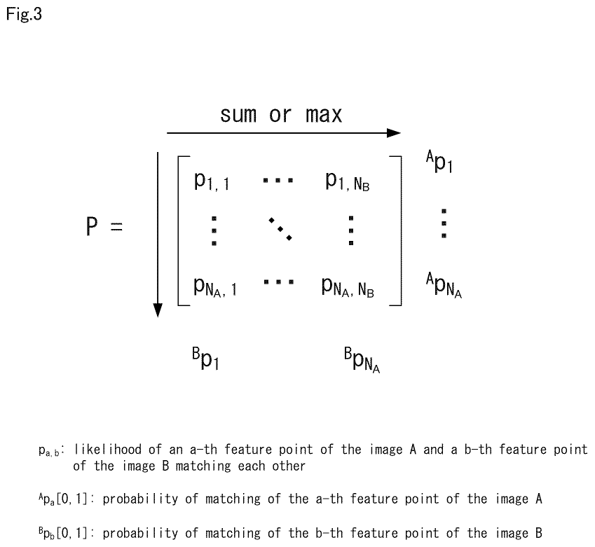

In exhaustive search matching, the combination specifying unit 12 calculates a matrix P illustrated in FIG. 3, and calculates, as a score for each combination of feature points, the probability of the two feature points matching each other. FIG. 3 is a diagram illustrating an example of a matrix used to specify a pair of feature points. Definitions of variables in FIG. 3 are as follows.
p_{a,b}: likelihood of an a-th feature point of the image A and a b-th feature point of the image B matching each other
^{A}pₐ∈[0,1]: probability of matching of the a-th feature point of the image A
^{B}p_{b}∈[0,1]: probability of matching of the b-th feature point of the image B

In addition, the combination specifying unit 12 can also calculate the above probability of matching of the a-th feature point of the image A and the above probability of matching of the b-th feature point of the image B, using a preset function.

In this manner, the combination specifying unit 12 performs provisional matching between feature points. Note that, in this case, one feature point may be combined with each of a plurality of feature points.

In the example embodiment, the normalization processing unit 13 calculates a centroid and standard deviation or a covariance matrix of the first feature points and a centroid and standard deviation or a covariance matrix of the second feature points, for the specified combinations, using, as weights, the scores calculated by the combination specifying unit 12. The normalization processing unit 13 then normalizes position information of the first feature points and the second feature points using the calculated centroids and standard deviation or covariance matrixes for the specified combinations.

Specifically, when the position information of an i-th feature point of an image is defined as xᵢ, the normalization processing unit 13 calculates a centroid c and standard deviation s of feature points using Expressions 1 and 2 below. pᵢ is a score (probability) calculated by the combination specifying unit 12 (see FIG. 3). The normalization processing unit 13 then applies the calculated centroid c and standard deviation s to Expression 3 below, and normalizes the position information xᵢ.

$${x}_{i}^{new}$$

indicates the normalized position information.

$$c = Mean ( {\{ {x}_{i} , {p}_{i} \}}_{i = 1}^{N} ) \qquad Expression 1$$

$$s = Std ( {\{ {x}_{i} , {p}_{i} \}}_{i = 1}^{N} ) \qquad Expression 2$$

$${x}_{i}^{new} = \frac{{x}_{i} - c}{s} \qquad Expression 3$$

In addition, when calculating a covariance matrix Σ, the normalization processing unit 13 uses Expression 4 below. In this case, the normalization processing unit 13 then applies the calculated centroid c and covariance matrix Σ to Expression 5 below, and normalizes the position information xᵢ.

$$\sum = Cov ( {\{ {x}_{i} , {p}_{i} \}}_{i = 1}^{N} ) \qquad Expression 4$$

$${x}_{i}^{new} = {\sum }^{- 1 / 2} ( {x}_{i} - c ) \qquad Expression 5$$

In addition, when a SIFT feature amount is calculated as a feature amount, the feature point extracting unit 11 detects the direction of a feature point at the time of extracting the feature point. In this case, the normalization processing unit 13 can also specify the directions of the first feature point and the second feature point for each of the specified combinations, and align the direction of the first feature point with the direction of the second feature point using the specified directions.

Specifically, first, the difference between a direction ^{A}θₐ of the a-th feature point of the image A and a direction ^{B}θ_{b} of the b-th feature point of the image B is defined as θ_{a,b}. In this case, the normalization processing unit 13 calculates an average vector when θ_{a,b} is regarded as a vector, using Expression 6 below, and sets the calculated average vector as a relative rotation angle θ_{B→A} from the image B to the image A.

$${θ}_{B \to A} = [ \begin{matrix}{θ}_{1 , 1} & ⋯ & {θ}_{1 , {N}_{B}} \\ ⋮ & ⋱ & ⋮ \\ {θ}_{{N}_{A} , 1} & ⋯ & {θ}_{{N}_{A} , {N}_{B}}\end{matrix} ] \qquad Expression 6$$

The normalization processing unit 13 then applies the calculated relative rotation angle θ_{B→A} and covariance matrix Σ to Expression 7 below, and normalizes the position information xᵢ. Note that, in Expression 7 below, the covariance matrix Σ represents normalization of a scale, and the standard deviation s may be used in place of the covariance matrix Σ. In addition, in Expression 7 below, R(θ_{B→A}) represents normalization of rotation. In addition, in Expression 7 below, the order of the covariance matrix Σ and R(θ_{B→A}) may be reversed.

$${}^{b} {x}_{b}^{new} = {\sum }^{- \frac{1}{2}} R ( {θ}_{B \to A} ) ( {x}_{b} - c ) \qquad Expression 7$$

In addition, the normalization processing unit 13 can also calculate the angle of the vector from the centroid c calculated using Expression 1 above to each feature point. In this case, letting the angle of the vector from the centroid to the a-th feature point of the image A be θₐ, and the angle of the vector from the centroid to the b-th feature point of the image B be θ_{b}, the difference between the former angle and the latter angle is defined as θ_{a,b}. Also in this case, the normalization processing unit 13 calculates a relative rotation angle θ_{B→A} from the image B to the image A using Expression 6 above, applies the calculated relative rotation angle θ_{B→A} and covariance matrix Σ to Expression 7 above, and normalizes the position information xᵢ.

In the example embodiment, the encoding unit 14 encodes the feature amounts of the first feature point and the second feature point a predetermined number of times (for example, L times) in a state where the normalized position information is added thereto. In the example embodiment, as will be described later, the matching processing unit 15 executes matching processing using a machine learning model, and thus encoding is performed such that the resultant data can be input 5 to the machine learning model.

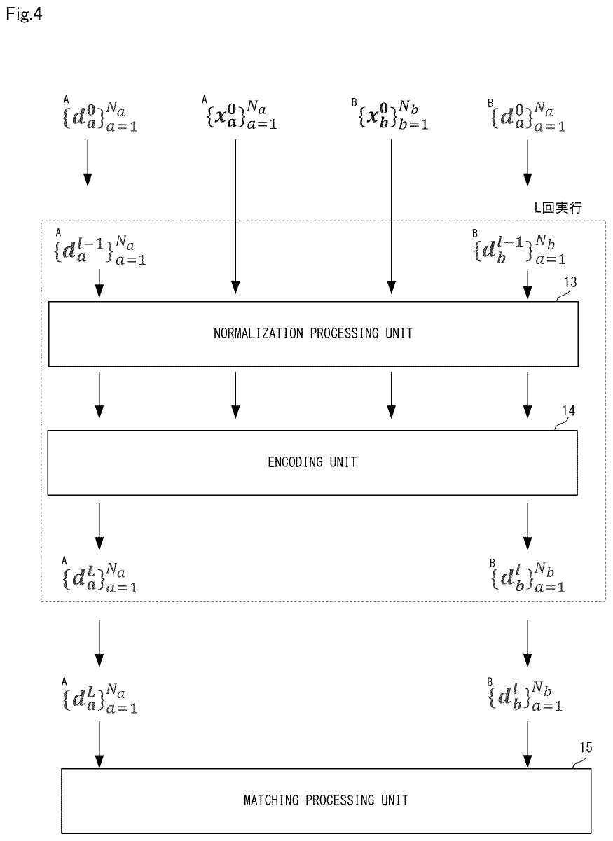

Processing that is performed by the normalization processing unit 13 and the encoding unit 14 will be described in detail with reference to FIG. 4. FIG. 4 is a diagram for describing an example of normalization processing and encoding processing that are performed in the image processing apparatus. First, the position information of feature points in the images A and B and the feature amounts of the feature points are defined as expressed in Expressions 8 and 9 below. In addition, in Expressions 8 and 9 below, Na indicates the total number of feature points extracted from the image A, and Nb indicates the total number of feature points extracted from the image B.

$${}^{A} {\{ {x}_{a} \}}_{a = 1}^{{N}_{a}} : Position information of the a - th feature point extracted from the image A \qquad Expression 8$$

$${}^{A} {\{ {d}_{a} \}}_{a = 1}^{{N}_{a}} : Feature amount ( descriptor ) of the a - th feature point extracted from the image A$$

$${}^{B} {\{ {x}_{b} \}}_{b = 1}^{{N}_{b}} : Position information of the b - th feature point extracted from the image B \qquad Expression 9$$

$${}^{B} {\{ {d}_{b} \}}_{b = 1}^{{N}_{b}} : Feature amount ( descriptor ) of the b - th feature point extracted from the image B$$

As illustrated in FIG. 4, first, the normalization processing unit 13 normalizes position information, and adds the normalized position information to the corresponding feature amount. Next, the encoding unit 142 encodes the feature amount to which the normalized position information has been added.

In the example in FIG. 4, normalization processing is performed by the normalization processing unit 13 once, while encoding processing is repeated by the encoding unit 14 L times, and a feature amount is updated L times. Normalized position information is added to a feature amount each time it is updated. In FIG. 4, the superscript index added to a feature amount d indicates the number of times the feature amount d was updated. In this manner, the feature amounts of feature points are encoded by the encoding unit 14 in a state where normalized position information is added thereto.

In the example embodiment, the matching processing unit 15 executes matching processing using, for example, a machine learning model. In this case, as training data of the machine learning model, the feature amounts and position information of two feature points and a label indicating whether or not the two feature points correspond to each other are used.

### [Apparatus Operations]

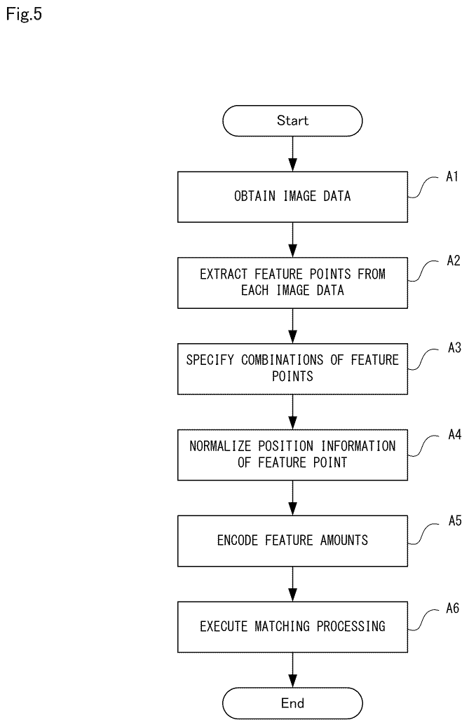

Next, operations of the image processing apparatus according to the example embodiment will be described with reference to FIG. 5. FIG. 5 is a flowchart illustrating an example of operations of the image processing apparatus. In the following description, FIGS. 1 to 4 will be referenced as appropriate. In addition, in the example embodiment, an image processing method is performed by operating the image processing apparatus 10. Thus, the following description of operations of the image processing apparatus 10 is given in place of a description of the image processing method.

As illustrated in FIG. 5, the image data obtaining unit 16 first obtains image data of two images designated by the user through an input device or a terminal device from an external terminal device, a database, or the like (step A1).

Next, the feature point extracting unit 11 extracts first feature points from a first image and extracts second feature points from a second image, using the image data obtained in step A1 (step A2). Specifically, the feature point extracting unit 11 calculates feature amounts for the images, and extracts, as feature points, points at which the value of the feature amount is greater than or equal to a predetermined value.

Next, the combination specifying unit 12 specifies combinations of a first feature point and a second feature point that satisfy a setting requirement, from among the first feature points and the second feature points extracted in step A2 (step A3). Specifically, the combination specifying unit 12 calculates scores for respective combinations of a first feature point and a second feature point, and specifies combinations for which the calculated score is greater than or equal to a threshold value.

Next, the normalization processing unit 13 normalizes the position information of a first feature point and a second feature point such that the position of the first feature point and the position of the second feature point become closer to each other, for each of the combinations specified in step A3 (step A4).

Specifically, the normalization processing unit 13 calculates a centroid and standard deviation or a covariance matrix of the first feature points and a centroid and standard deviation or a covariance matrix of the second feature points for the specified combinations, using the scores calculated in step A3 as weights. The normalization processing unit 13 then normalizes the position information of the first feature points and the second feature points for the specified combinations, using the calculated centroids and standard deviation or covariance matrixes.

Next, the encoding unit 14 encodes the feature amounts (descriptors) of the first feature points and the second feature points in a state where the normalized position information is added thereto (step A5). Specifically, the encoding unit 14 encodes the feature amounts of the first feature points and the second feature points a predetermined number of times (for example, L times) in a state where the normalized position information is added thereto.

Next, the matching processing unit 15 executes matching processing on the encoded first feature points and second feature points using, for example, a machine learning model, and specifies a pair of first and second feature points that correspond to each other (step A6). After execution of step A6, the matching processing unit 15 outputs information for specifying the specified pair of feature points.

### Effects in Example Embodiment

As described above, in the image processing apparatus 10, after the position information is normalized, the feature amounts are encoded, and then feature point matching is executed. For this reason, even if the first image and the second image are, for example, an enlarged image of a target object and an overall image of the target object and the positions of the target object in the images are largely different from each other, a decrease in the accuracy of feature point matching is avoided. That is to say, the image processing apparatus 10 makes it possible to improve the accuracy of feature point matching in a portion whose position differs between images.

In addition, in the above example, the first feature points and the second feature points are extracted from images, but in the present disclosure, the extraction source of the feature points is not limited. That is to say, the first feature points and the second feature points may be extracted from an n-dimensional group of feature points generated based on images, such as three-dimensional point cloud data.

The present disclosure can be generally used for problems of finding a pair of the same points in an n-dimensional space when there are, in the n-dimensional space, two groups ({^{A}xᵢ, ^{A}dᵢ}ᵢ, {^{B}xⱼ, ^{B}dⱼ}ⱼ) of combinations of position information xᵢ of a specific point and a D-dimensional feature vector (feature amount) dᵢ corresponding thereto.

### Modified Example

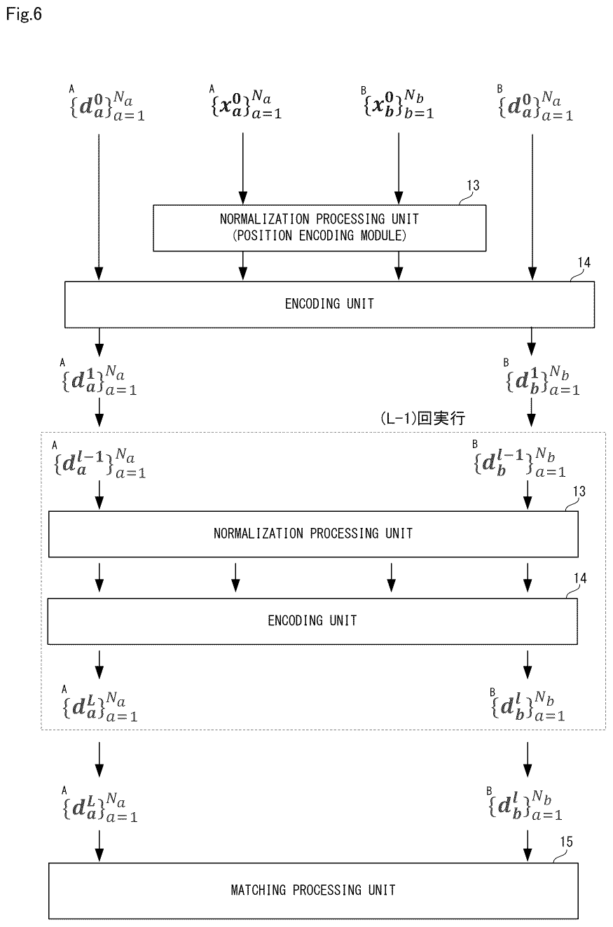

Here, a modified example of processing that is performed by the normalization processing unit 13 and the encoding unit 14 will be described with reference to FIG. 6. FIG. 6 is a diagram illustrating another example of encoding processing that is performed in the image processing apparatus.

As illustrated in FIG. 6, in the modified example, the normalization processing unit 13 includes a position encoding module. The position encoding module encodes only position information, and inputs the encoded position information to the encoding unit 14. For this reason, in the example in FIG. 6, the encoding unit 14 adds the encoded position information to the corresponding feature amount, and encodes the feature amount once in this state.

Next, the normalization processing unit 13 receives the encoded feature amount, and executes normalization processing on the position information added to the feature amount. The encoding unit 14 then executes encoding processing on the feature amount to which the normalized position information is added. In this case, encoding processing has already been executed once, and thus encoding processing is executed (L-1) times. In the modified example, encoding processing that does not involve normalization is performed on position information first.

### [Program]

The program in the example embodiment need only be a program that causes a computer to execute steps A1 to A6 shown in FIG. 5. The image processing apparatus and the i image processing method can be realized, by this program being installed on a computer and executed. In this case, a processor of the computer performs processing while functioning as the feature point extracting unit 11, the combination specifying unit 12, the normalization processing unit 13, the encoding unit 14, the matching processing unit 15, and the image data obtaining unit 16. Examples of the computer include a general-purpose PC, server computer, as well as a smartphone and a tablet-type terminal device.

The program in the example embodiment may also be executed by a computer system constructed from a plurality of computers. In this case, for example, each computer may function as one of the feature point extracting unit 11, the combination specifying unit 12, the normalization processing unit 13, the encoding unit 14, the matching processing unit 15, and the image data obtaining unit 16.

### [Physical Configuration]

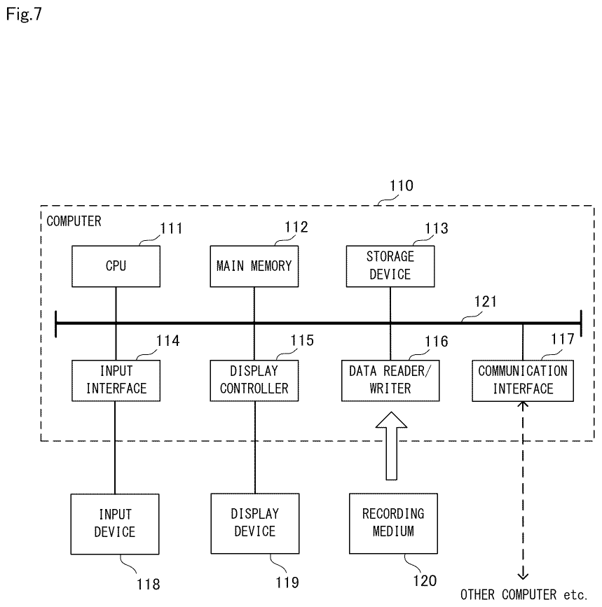

Here, a computer that realizes the image processing apparatus 10 by executing the program will be described with reference to FIG. 7. FIG. 7 is a block diagram illustrating an example of a computer that realizes the image processing apparatus.

As illustrated in FIG. 7, a computer 110 includes a CPU 111, a main memory 112, a storage device 113, an input interface 114, a display controller 115, a data reader/writer 116, and a communication interface 117. These units are connected via a bus 121 so as to be able to perform data communication with each other.

The computer 110 may include a GPU (Graphics Processing Unit) or a FPGA (Field-Programmable Gate Array) in addition to the CPU 111 or instead of the CPU 111. In this case, the GPU or the FPGA may execute the program.

The CPU 111 loads programs (codes) according to the present example embodiment stored in the storage device 113 to the main memory 112, and executes the programs in a predetermined order to perform various kinds of calculations. The main memory 112 is typically a volatile storage device such as a DRAM (Dynamic Random Access Memory).

Also, the program according to the present example embodiment is provided in the state of being stored in a computer-readable recording medium 120. Note that programs according to the present example embodiment may be distributed on the Internet that is connected via the communication interface 117.

Specific examples of the storage device 113 include a hard disk drive, and a semiconductor storage device such as a flash memory. The input interface 114 mediates data transmission between the CPU 111 and an input device 118 such as a keyboard or a mouse. The display controller 115 is connected to a display device 119 and controls the display of the display device 119.

The data reader/writer 116 mediates data transmission between the CPU 111 and the recording medium 120, reads out programs from the recording medium 120, and writes the results of processing performed by the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

Note that the information processing apparatus can also be realized by using hardware (for example, electronic circuits) corresponding to the units, in place of a computer that has programs installed therein. Furthermore, a configuration may also be adopted in which a portion of the image processing apparatus 10 is realized by programs, and the remaining portion of the image processing apparatus 10 is realized by hardware. In the example embodiment, the computer is not limited to the computer illustrated in FIG. 7.

One or all of the above-described example embodiments can be expressed as, but are not limited to, Supplementary Note 1 to Supplementary Note 15 described below.

### Supplementary Note 1

An image processing apparatus comprising:
a feature point extracting unit configured to extract first feature points from a first image, and extract second feature points from a second image obtained by capturing an image of a portion of a subject in the first image;
a combination specifying unit configured to specify combinations of a first feature point and a second feature point that satisfy a setting requirement, from among the extracted first feature points and the second feature points;
a normalization processing unit configured to normalize position information of a first feature point and a second feature point such that a position of the first feature point and a position of the second feature point become closer to each other, for each of the specified combinations;
an encoding unit configured to encode feature amounts of the first feature point and the second feature point in a state where the normalized position information is added thereto; and
a matching processing unit configured to execute matching processing on the encoded first feature point and second feature point, and specify a pair of first and second feature points that correspond to each other.

### Supplementary Note 2

The image processing apparatus according to supplementary note 1,
wherein the combination specifying unit calculates scores for respective combinations of a first feature point and a second feature point, and specifies combinations for which the calculated score is greater than or equal to a threshold value.

### Supplementary Note 3

The image processing apparatus according to supplementary note 2,
wherein the normalization processing unit calculates a centroid and standard deviation or a covariance matrix of the first feature points and a centroid and standard deviation or a covariance matrix of the second feature points using the scores as weights, for the specified combinations, and normalizes position information of the first feature points and the second feature points using the calculated centroids and standard deviation or covariance matrixes.

### Supplementary Note 4

The image processing apparatus according to supplementary note 3,
wherein the normalization processing unit further specifies directions of the first feature point and the second feature point for each of the specified combinations, and aligns the direction of the first feature point with the direction of the second feature point using the specified directions.

### Supplementary Note 5

The image processing apparatus according to supplementary note 1,
wherein the first image is an image obtained by capturing an image of a structure, and the second image is an image obtained by capturing an image of a portion of the structure.

### Supplementary Note 6

An image processing method comprising:
a feature point extracting step of extracting first feature points from a first image, and extracting second feature points from a second image obtained by capturing an image of a portion of a subject in the first image;
a combination specifying step of specifying combinations of a first feature point and a second feature point that satisfy a setting requirement, from among the extracted first feature points and the second feature points;
a normalization processing step of normalizing position information of a first feature point and a second feature point such that a position of the first feature point and a position of the second feature point becomes closer to each other, for each of the specified combinations;
an encoding step of encoding feature amounts of the first feature point and the second feature point in a state where the normalized position information is added thereto; and
a matching processing step of executing matching processing on the encoded first feature point and second feature point, and specifying a pair of first and second feature points that correspond to each other.

### Supplementary Note 7

The image processing method according to supplementary note 6,
wherein, in the combination specifying step, scores are calculated for respective combinations of a first feature point and a second feature point, and combinations for which the calculated score is greater than or equal to a threshold value are specified.

### Supplementary Note 8

The image processing method according to supplementary note 7,
wherein, in the normalization processing step, a centroid and standard deviation or a covariance matrix of the first feature points and a centroid and standard deviation or a covariance matrix of the second feature points are calculated using the scores as weights, for the specified combinations, and position information of the first feature points and the second feature points is normalized using the calculated centroids and standard deviation or covariance matrixes.

### Supplementary Note 9

The image processing method according to supplementary note 8.
wherein, in the normalization processing step, directions of the first feature point and the second feature point are further specified for each of the specified combinations, and the direction of the first feature point and the direction of the second feature point are aligned using the specified directions.

### Supplementary Note 10

The image processing method according to supplementary note 6,
wherein the first image is an image obtained by capturing an image of a structure, and the second image is an image obtained by capturing an image of a portion of the structure.

### Supplementary Note 11

A computer-readable recording medium that includes a program including instructions recorded thereon, the instructions causing a computer to carry out:
a feature point extracting step of extracting first feature points from a first image, and extracting second feature points from a second image obtained by capturing an image of a portion of a subject in the first image;
a combination specifying step of specifying combinations of a first feature point and a second feature point that satisfy a setting requirement, from among the extracted first feature points and the second feature points;
a normalization processing step of normalizing position information of a first feature point and a second feature point such that a position of the first feature point and a position of the second feature point become closer to each other, for each of the specified combinations;
an encoding step for encoding feature amounts of the first feature point and the second feature point in a state where the normalized position information is added thereto; and
a matching processing step of executing matching processing on the encoded first feature point and second feature point, and specifying a pair of first and second feature points that correspond to each other.

### Supplementary Note 12

The computer-readable recording medium according to supplementary note 11,
wherein, in the combination specifying step, scores are calculated for respective combinations of a first feature point and a second feature point, and a combination for which the calculated score is greater than or equal to a threshold value is specified.

### Supplementary Note 13

The computer-readable recording medium according to supplementary note 12,
wherein, in the normalization processing step, a centroid and standard deviation or a covariance matrix of the first feature points and a centroid and standard deviation or a covariance matrix of the second feature points are calculated using the scores as weights, for the specified combinations, and position information of the first feature points and the second feature points is normalized using the calculated centroids and standard deviation or covariance matrixes.

### Supplementary Note 14

The computer-readable recording medium according to supplementary note 13,
wherein, in the normalization processing step, directions of the first feature point and the second feature point are further specified for each of the specified combinations, and the direction of the first feature point and the direction of the second feature point are aligned using the specified directions.

### Supplementary Note 15

The computer-readable recording medium according to supplementary note 11,
wherein the first image is an image obtained by capturing an image of a structure, and the second image is an image obtained by capturing an image of a portion of the structure.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

As described above, according to the invention, it is possible to improve the accuracy of feature point matching in a portion whose position differs between images. The present disclosure is useful for an image processing system executing feature point matching process.

### REFERENCE SIGNS LIST

10 image processing apparatus
11 Feature point extracting unit
12 Combination specifying unit
13 Normalization processing unit
14 Encoding unit
15 Matching processing unit
16 Image data obtaining unit
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. An image processing apparatus comprising:
at least one memory storing instructions; and
at least one processor configured to execute the instructions to:
extract first feature points from a first image, and extract second feature points from a second image obtained by capturing an image of a portion of a subject in the first image;
specify combinations of a first feature point and a second feature point that satisfy a setting requirement, from among the extracted first feature points and the second feature points;
normalize position information of a first feature point and a second feature point such that a position of the first feature point and a position of the second feature point become closer to each other, for each of the specified combinations;
to encode feature amounts of the first feature point and the second feature point in a state where the normalized position information is added thereto; and
execute matching processing on the encoded first feature point and second feature point, and specify a pair of first and second feature points that correspond to each other.

2. The image processing apparatus according to claim 1,
wherein the one or more processors further calculates scores for respective combinations of a first feature point and a second feature point, and specifies combinations for which the calculated score is greater than or equal to a threshold value.

3. The image processing apparatus according to claim 2,
wherein the one or more processors further calculates a centroid and standard deviation or a covariance matrix of the first feature points and a centroid and standard deviation or a covariance matrix of the second feature points using the scores as weights, for the specified combinations, and normalizes position information of the first feature points and the second feature points using the calculated centroids and standard deviation or covariance matrixes.

4. The image processing apparatus according to claim 3,
wherein the one or more processors further specifies directions of the first feature point and the second feature point for each of the specified combinations, and aligns the direction of the first feature point with the direction of the second feature point using the specified directions.

5. The image processing apparatus according to claim 1,
wherein the first image is an image obtained by capturing an image of a structure, and the second image is an image obtained by capturing an image of a portion of the structure.

6. An image processing method comprising:
a feature point extracting step of extracting first feature points from a first image, and extracting second feature points from a second image obtained by capturing an image of a portion of a subject in the first image;
a combination specifying step of specifying combinations of a first feature point and a second feature point that satisfy a setting requirement, from among the extracted first feature points and the second feature points;
a normalization processing step of normalizing position information of a first feature point and a second feature point such that a position of the first feature point and a position of the second feature point becomes closer to each other, for each of the specified combinations;
an encoding step of encoding feature amounts of the first feature point and the second feature point in a state where the normalized position information is added thereto; and
a matching processing step of executing matching processing on the encoded first feature point and second feature point, and specifying a pair of first and second feature points that correspond to each other.

7. The image processing method according to claim 6,
wherein, in the combination specifying step, scores are calculated for respective combinations of a first feature point and a second feature point, and combinations for which the calculated score is greater than or equal to a threshold value are specified.

8. The image processing method according to claim 7,
wherein, in the normalization processing step, a centroid and standard deviation or a covariance matrix of the first feature points and a centroid and standard deviation or a covariance matrix of the second feature points are calculated using the scores as weights, for the specified combinations, and position information of the first feature points and the second feature points is normalized using the calculated centroids and standard deviation or covariance matrixes.

9. The image processing method according to claim 8.
wherein, in the normalization processing step, directions of the first feature point and the second feature point are further specified for each of the specified combinations, and the direction of the first feature point and the direction of the second feature point are aligned using the specified directions.

10. The image processing method according to claim 6,
wherein the first image is an image obtained by capturing an image of a structure, and the second image is an image obtained by capturing an image of a portion of the structure.

11. A non-transitory computer-readable recording medium that includes a program including instructions recorded thereon, the instructions causing a computer to carry out:
a feature point extracting step of extracting first feature points from a first image, and extracting second feature points from a second image obtained by capturing an image of a portion of a subject in the first image;
a combination specifying step of specifying combinations of a first feature point and a second feature point that satisfy a setting requirement, from among the extracted first feature points and the second feature points;
a normalization processing step of normalizing position information of a first feature point and a second feature point such that a position of the first feature point and a position of the second feature point become closer to each other, for each of the specified combinations;
an encoding step for encoding feature amounts of the first feature point and the second feature point in a state where the normalized position information is added thereto; and
a matching processing step of executing matching processing on the encoded first feature point and second feature point, and specifying a pair of first and second feature points that correspond to each other.

12. The non-transitory computer-readable recording medium according to claim 11,
wherein, in the combination specifying step, scores are calculated for respective combinations of a first feature point and a second feature point, and a combination for which the calculated score is greater than or equal to a threshold value is specified.

13. The non-transitory computer-readable recording medium according to claim 12,
wherein, in the normalization processing step, a centroid and standard deviation or a covariance matrix of the first feature points and a centroid and standard deviation or a covariance matrix of the second feature points are calculated using the scores as weights, for the specified combinations, and position information of the first feature points and the second feature points is normalized using the calculated centroids and standard deviation or covariance matrixes.

14. The non-transitory computer-readable recording medium according to claim 13,
wherein, in the normalization processing step, directions of the first feature point and the second feature point are further specified for each of the specified combinations, and the direction of the first feature point and the direction of the second feature point are aligned using the specified directions.

15. The non-transitory computer-readable recording medium according to claim 11,
wherein the first image is an image obtained by capturing an image of a structure, and the second image is an image obtained by capturing an image of a portion of the structure.
